(19) United States
(12) Patent Application Publication
(10) Pub. No.: US 2021/0368267 A1
(43) Pub. Date: Nov. 25, 2021

(54) STEREOPHONIC BALANCE OF DISPLAYS

(71) Applicant: Hewlett-Packard Development Company, L.P., Spring, TX (US)

(72) Inventors: Dimitre Mehandjiysky, Spring, TX (US); Syed S. Azam, Spring, TX (US); Mats Anders Krister Luckman, Spring, TX (US)

(73) Assignee: Hewlett-Packard Development Company, L.P., Spring, TX (US)

(21) Appl. No.: 17/042,439

(22) PCT Filed: Jul. 20, 2018
(86) PCT No.: PCT/US2018/043126

§ 371 Date: Sep. 28, 2020

(51) Int. Cl. H04R 5/02; H04R 1/32

(52) U.S. Cl. CPC H04R 5/02; H04R 2499/15; H04R 1/323

(57) ABSTRACT

In some examples, a system can include a display comprising an enclosure with audio devices positioned within the enclosure, and a computing device comprising instructions executable by a processing resource to: determine an orientation of the display and alter a stereophonic balance of the audio devices based on the determined orientation of the display.

### BACKGROUND

Displays can be utilized to display images, videos, user interfaces, among other visual media. Displays can also be utilized with audio devices. Audio devices or speakers can be utilized to generate sound that corresponds to the visual media displayed on the display. For example, a video can include images that can be displayed as a corresponding sound is generated by the audio devices.

### BRIEF DESCRIPTION OF THE DRAWINGS

FIG. 1 is a block diagram of an example of a system for stereophonic balance of displays consistent with the disclosure.

FIG. 2 is a block diagram of an example of a memory resource for stereophonic balance of displays consistent with the disclosure.

FIG. 3 is a block diagram of an example of a system for stereophonic balance of displays consistent with the disclosure.

FIG. 4 illustrates an example of a system for stereophonic balance of displays consistent with the disclosure.

FIG. 5 illustrates an example of a system for stereophonic balance of displays consistent with the disclosure.

FIG. 6 illustrates an example of a system for stereophonic balance of displays consistent with the disclosure.

FIG. 7 illustrates an example of a system for stereophonic balance of displays consistent with the disclosure.

### DETAILED DESCRIPTION

Displays, computing devices, and memory resources that are capable of stereophonic balancing of audio devices are described herein. In some examples, a display can include a device for displaying images. For example, a display can include a computer monitor, a television, a smart phone screen, a tablet screen, and/or other type of device that is capable of displaying images or video.

In some examples, the displays described herein can include audio devices that are embedded within an enclosure of the display. For examples, the display can include an enclosure that surrounds electrical devices of the display. In this example, the enclosure can be utilized to protect electrical devices such as computing devices, power supplies, circuit assemblies, or other types of electrical devices that are utilized by the display.

In some examples, the audio devices embedded within the enclosure of the display can be piezo audio devices (e.g., piezoelectric speaker, etc.). As used herein, a piezo audio device can be a loudspeaker that utilizes a piezoelectric effect for generating sound waves. In some examples, the piezo audio devices can be activated by applying a voltage to a piezoelectric material to create a mechanical motion that can generate sound waves. In some examples, the piezoelectric material can be a crystal material, a ceramic material, and/or other types of materials that can accumulate an electric charge to provide a piezoelectric effect.

In some examples, the displays described herein can include an array of audio devices and/or an array of piezo audio devices. As used herein, an array of audio devices can include a plurality of audio devices that can be controlled individually or together. In some examples, the displays described herein can be rotated to different orientations. In these examples, the stereophonic balance of the audio devices within the enclosure of the display can be adjusted or altered based on the orientation of the display. In this way, the sound quality of the audio devices can be maintained when the display is rotated. As used herein, the stereophonic balance can be a combination of audio direction and/or channel assignment for each of the audio devices. For example, the stereophonic balance can include a direction sound is generated toward for each of a plurality of audio devices. In other examples, the stereophonic balance can be the channel assignment (e.g., right channel, left channel, center channel, etc.) for each of a plurality of audio devices.

In some examples, the displays described herein can generate multiple viewing areas that can be utilized by multiple users. In these examples, the stereophonic balance of the audio devices can be altered to provide better sound quality to each of the multiple users utilizing a corresponding viewing area. Thus, the audio devices can dynamically be altered when the orientation or viewing areas of the display are altered.

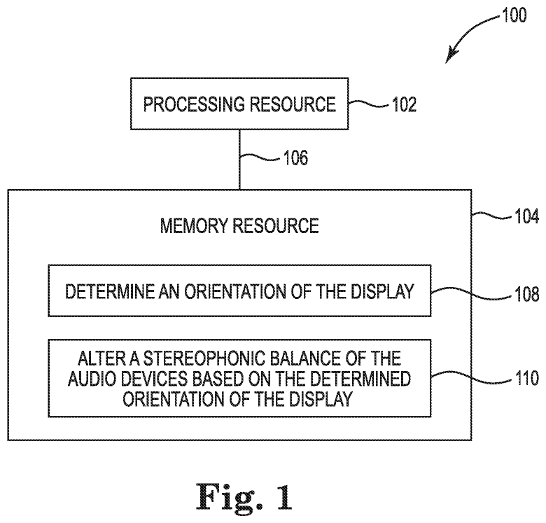

FIG. 1 is a block diagram of an example of a system 100 for stereophonic balance of displays consistent with the disclosure. In some examples, the system 100 can include a memory resource 104 that can be utilized to store instructions 108, 110 that can be executed by a processing resource 102 to perform functions described herein. In some examples, the processing resource 102 can be coupled to the memory resource 104 via a connection 106. Connection 106 can be a physical or wireless communication connection that can be utilized to transfer data signals between the processing resource 102 and the memory resource 104.

A processing resource 102 may be a central processing unit (CPU), microprocessor, and/or other hardware device suitable for retrieval and execution of instructions stored in memory resource 104. In the particular example shown in FIG. 1, processing resource 102 may receive, determine, and send instructions 108, 110. As an alternative or in addition to retrieving and executing instructions 108, 110, processing resource 102 may include an electronic circuit comprising a number of electronic components for performing the operations of the instructions 108, 110 in the memory resource 104. With respect to the executable instruction representations or boxes described and shown herein, it should be understood that part or all of the executable instructions 108, 110 and/or electronic circuits included within one box may be included in a different box shown in the figures or in a different box not shown.

Memory resource 104 may be any electronic, magnetic, optical, or other physical storage device that stores executable instructions 108, 110. Thus, memory resource 104 may be, for example, Random Access Memory (RAM), an Electrically-Erasable Programmable Read-Only Memory (EEPROM), a storage drive, an optical disc, and the like. The executable instructions 108, 110 may be stored on the memory resource 104. Memory resource 104 may be a portable, external or remote storage medium, for example, that allows the system 100 to download the instructions 108, 110 from the portable/external/remote storage medium. In this situation, the executable instructions 108, 110 may be part of an “installation package”. As described herein, memory resource 104 may be encoded with executable instructions 108, 110 for remote device configurations as described herein.

In some examples, the system 100 can be coupled to a display. For example, the system 100 can be embedded within an enclosure of the display. In another example, the processing resource 102 can be a processing resource of the display or computing device coupled to the display. For example, the display can be a computer display that can be coupled to a computing device. In some examples, the system 100 can include a display comprising an enclosure with audio devices positioned within the enclosure.

In some examples, the memory resource 104 can include instructions 108 that are executable by the processing resource 102 to determine an orientation of the display. In some examples, the orientation of the display can be a position or location of the edges or sides of the display. For example, the display can include a first set of sides that are a first length and a second set of sides that are a second length. In this example, the display can be a rectangle when the first length is different than the second length or the display can be a square when the first length is the same as the second length.

In some examples, the orientation of the display can be the relative position of the first set of sides and the second set of sides. For example, a first orientation of the display can exist when the first set of sides represent a top side and a bottom side of the display while the second set of sides represent a right side and a left side of the display. In this example, a second orientation of the display can exist when the first set of sides represent a right side and a left side while the second set of sides represent a top side and a bottom side. In this example, the orientation of the display can be altered from the first orientation to the second orientation. In some examples, a plurality of orientations can also exist at each of a plurality of angles between the first orientation and the second orientation when the display is rotatable. For example, an orientation can exist for each angle of rotation when the display is rotatable 360 degrees.

In some examples, the orientation and/or angle of rotation of the display can be determined utilizing a number of sensors coupled to the display. For example, a gyroscope sensor, an orientation sensor, and/or an accelerometer sensor can be utilized to determine the orientation and/or angle of rotation of the display. In some examples, the number of sensors coupled to the display can provide real time determinations of the orientation and/or angle of ration of the display. Thus, the number of sensors can be utilized to determine a real time orientation of the display such that the audio devices can be dynamically altered based on the real time orientation of the display.

In some examples, the memory resource 104 can include instructions 110 that are executable by the processing resource 102 to alter a stereophonic balance of the audio devices based on the determined orientation of the display. As described herein, the stereophonic balance of the audio devices can include a direction that the audio devices are directing generated sound and/or a channel assignment that is assigned to the audio devices. For example, the stereophonic balance of the audio devices can include an assignment of direction to generate the sound for each of the audio devices and/or a channel assignment for each of the audio devices. That is, the stereophonic balance can include a directionality of a sound generated by the audio devices.

In some examples, the stereophonic balance includes right channel, center channel, and/or left channel assignments for the audio devices. For example, a first portion of the audio devices can be assigned to a right channel assignment, a second portion of the audio devices can be assigned to a center channel assignment, and a third portion of the audio devices can be assigned to a left channel assignment. In some examples, the right channel assignment can be utilized to generate sound directed from the right side of the display at a particular orientation. In some examples, the center channel assignment can be utilized to generate sound directed from a center portion of the display. In some examples, the left channel assignment can be utilized to generate sound directed from a left side of the display.

In some examples, the channel assignments can be assignments directed to a sound environment. As used herein, a sound environment can be a stereo sound environment that utilizes multiple sound directions and/or multiple sound sides to generate a surround sound from a plurality of directions. For example, the sound environment can include sounds that are directed to specific directions and/or specific sides of the display. In some examples, the display can be split by dividing lines into a plurality of portions such that each portion of the display includes embedded audio devices that are designated to generate sound for a corresponding portion of the display. In some examples, altering the stereophonic balance of the audio devices can include individually altering the stereophonic balance of each of the audio devices.

In some examples, the dividing lines for the display can be based on the orientation of the display. For example, the display can have a first dividing line at a first orientation. In this example, the display can be in a landscape orientation. As used herein, a landscape orientation can include an orientation when the display has a top side and bottom side that is relatively longer than the top side and the bottom side. In this example, the display can have a second dividing line at a second orientation when the second orientation is different than the first orientation. Thus, a dividing line can be utilized to divide the display into a plurality of portions and alter a first portion of the audio devices to a first stereophonic balance and alter a second portion of the audio devices to a second stereophonic balance based on the orientation of the display.

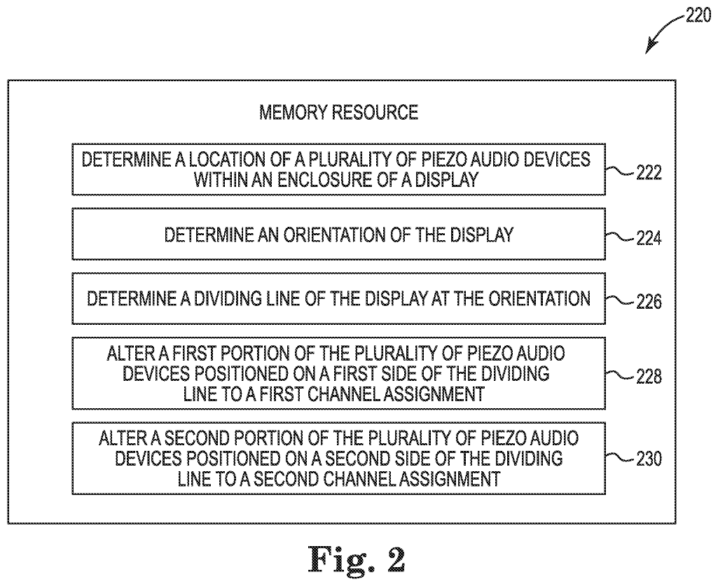

FIG. 2 is a block diagram of an example of a memory resource 220 for stereophonic balance of displays consistent with the disclosure. Memory resource 220 may be any electronic, magnetic, optical, or other physical storage device that stores executable instructions 222, 224, 226, 228, 230. Thus, memory resource 220 may be, for example, Random Access Memory (RAM), an Electrically-Erasable Programmable Read-Only Memory (EEPROM), a storage drive, an optical disc, and the like. The executable instructions 222, 224, 226, 228, 230 may be stored on the memory resource 220. Memory resource 220 may be a portable, external or remote storage medium, for example, that allows the memory resource 220 to download the instructions 222, 224, 226, 228, 230 from the portable/external/remote storage medium. In this situation, the executable instructions 222, 224, 226, 228, 230 may be part of an “installation package”. As described herein, memory resource 220 may be encoded with executable instructions 222, 224, 226, 228, 230 for remote device configurations as described herein.

In some examples, the memory resource 220 can be coupled to a display. For example, the display can be coupled to a processing resource that can execute the instructions 222, 224, 226, 228, 230 stored in the memory resource 220. In some examples, the memory resource 220 can be positioned within the enclosure of the display. In other examples, the memory resource 220 can be a remote device communicatively coupled to the display or computing device coupled to the display.

In some examples, the memory resource 220 can include instructions 222 that are executable by a processing resource to determine a location of a plurality of piezo audio devices within an enclosure of a display. In some examples, the plurality of piezo audio devices can be audio devices that utilize a piezoelectric material to generate sound waves. In some examples, the plurality of piezo audio devices can be arranged as an array within the enclosure of the display. In some examples, the array of piezo audio devices can be distributed from a first side to a second side of the display. As described herein, the plurality of piezo audio devices can be individually altered as an array of piezo audio devices based on an orientation of the display. In this way, a physical location of the piezo audio devices can be determined to identify a physical location of the plurality of piezo audio devices with respect to a dividing line and/or the orientation of the display.

In some examples, the memory resource 220 can include instructions 224 that are executable by a processing resource to determine an orientation of the display. As described herein, the orientation of the display can be a position or location of the edges or sides of the display. In some examples, the orientation of the display can be the relative position of a first set of sides and a second set of sides. For example, a first orientation of the display can exist when the first set of sides represent a top side and a bottom side of the display while the second set of sides represent a right side and a left side of the display. As described herein, the orientation of the display can be determined utilizing a number of sensors.

In some examples, the memory resource 220 can include instructions 226 that are executable by a processing resource to determine a dividing line of the display at the orientation. In some examples, a dividing line can be determined based on a quantity of channel assignments. For example, a single dividing line to separate the display into two portions can be utilized when two channel assignments exist. For example, a computing device can utilize two channels to produce a particular sound environment. In this example, the two channels can include a left channel assignment and a right channel assignment. In another example, two dividing lines can be utilized to separate the display into three portions when three channel assignments exist. For example, a computing device can utilize three channels to produce a particular sound environment. In this example, the three channels can include a left channel, a center channel, and a right channel. In this way, the display can be separated by dividing lines such that the channel assignments can be provided to each of the plurality of piezo audio devices based on the orientation of the display.

In some examples, the memory resource 220 can include instructions 228 that are executable by a processing resource to alter a first portion of the plurality of piezo audio devices positioned on a first side of the dividing line to a first channel assignment. In some examples, the orientation of the display can be determined and based on the orientation a dividing line can be determined. In some examples, a plurality of dividing lines can be determined for the display.

As described herein, a quantity of dividing lines can be based on a quantity of channel assignments to be utilized by the monitor. For example, a first monitor that utilizes two channel assignments can utilize a single dividing line to generate two portions of the display and a second monitor that utilizes three channel assignments can utilize two dividing lines to generate three portions of the display. In these examples, piezo audio devise within each portion can be assigned or altered to a corresponding channel assignment.

In some examples, the dividing line can generate two portions. In some examples, the first portion can be a first side of the display. In some examples, the first portion or first side of the display can include a physical portion that includes a physical location of the first portion of piezo audio devices. In these examples, piezo audio devices that are physically located on the first side of the display can be altered to the first channel assignment. In some examples, the display can be rotated such that the physical location of a number of piezo audio devices move from the first portion of the display to the second portion. In these examples, the number of piezo audio devices that moved from the first portion to the second portion can be altered to the channel assignment of the second portion.

In some examples, the memory resource 220 can include instructions 230 that are executable by a processing resource to alter a second portion of the plurality of piezo audio devices positioned on a second side of the dividing line to a second channel assignment. As described herein, the dividing line can generate portions of the display. In some examples, the second side of the dividing line can be a second portion of the display. Thus, the second portion of the display can include a physical portion of the display that includes the second portion of the plurality of piezo audio devices when the display is in a particular orientation. As described herein, the dividing line can remain in the same or similar location as the display is rotated to a different orientation. When the display is rotated or moved to the different location, a physical location of on of the second portion of the plurality of piezo audio devise can be moved from the second side to the first side and dynamically be altered to the first channel assignment.

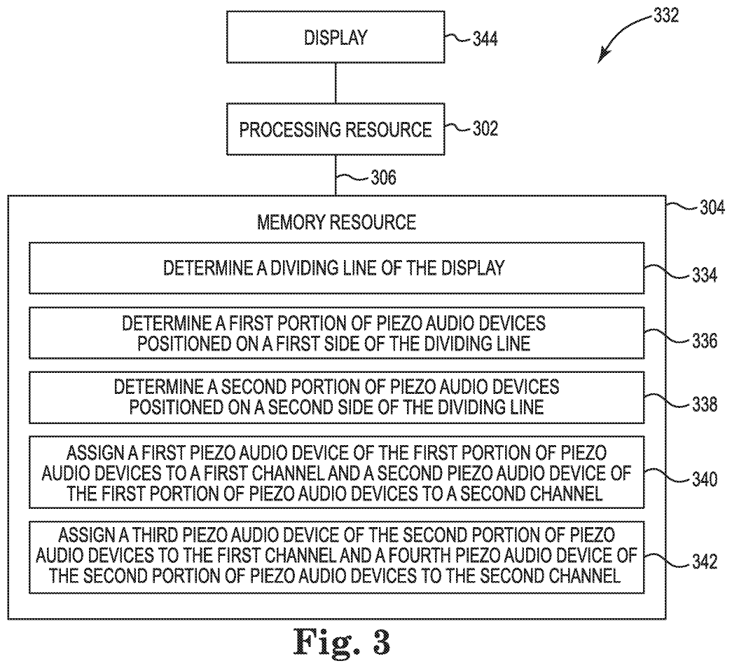

FIG. 3 is a block diagram of an example of a system 332 for stereophonic balance of displays consistent with the disclosure. In some examples, the system 332 can include a memory resource 304 that can be utilized to store instructions 334, 336, 338, 340, 342 that can be executed by a processing resource 302 to perform functions described herein. In some examples, the processing resource 302 can be coupled to the memory resource 304 via a connection 306. Connection 306 can be a physical or wireless communication connection that can be utilized to transfer data signals between the processing resource 302 and the memory resource 304.

A processing resource 302 may be a central processing unit (CPU), microprocessor, and/or other hardware device suitable for retrieval and execution of instructions stored in memory resource 304. Memory resource 304 may be any electronic, magnetic, optical, or other physical storage device that stores executable instructions 334, 336, 338, 340, 342. In some examples, the processing resource 302 can be the same or similar device as processing resource 102 as referenced in FIG. 1. In some examples, the memory resource 304 can be the same or similar device as memory resource 104 as referenced in FIG. 1.

In some examples, the system 332 can include a display 344 coupled to the processing resource 302 via a connection. For example, the processing resource 302 can be positioned within an enclosure of the display 344. In some examples, the display 344 can include an array of piezo audio devices positioned within an enclosure of the display. In some examples, the array of piezo audio devices includes a plurality of piezo audio devices positioned within the enclosure.

In some examples, the memory resource 304 can include instructions 334 that are executable by the processing resource 302 to determine a dividing line of the display 344. In some examples, a dividing line can be determined based on a quantity of channel assignments to be assigned to portions of the display 344. For example, a particular sound system utilized by the display 344 and/or computing device coupled to the display 344 can utilize a stereo sound system that utilizes a plurality of channel assignments. In these examples, a dividing line or plurality of dividing lines can be utilized to generate portions of the display 344. In these examples, the portions of the display can be physical portions or divisions of the display that each include a portion of the plurality of piezo audio devices.

In some examples, the memory resource 304 can include instructions 336 that are executable by the processing resource 302 to determine a first portion of piezo audio devices positioned on a first side of the dividing line. As described herein, the first portion of piezo audio devices positioned on the first side of the dividing line can be piezo audio devices that are physically positioned on the first side of the dividing line in a particular orientation. For example, the dividing line can divide the display into a plurality of portions. In this example, the dividing line can remain in the same location even when the display is rotated or moved. In this example, the piezo audio devices positioned on the first side of the dividing line can be moved to the second side of the dividing line or at a different physical location on the first side of the dividing line.

In some examples, the memory resource 304 can include instructions 338 that are executable by the processing resource 302 to determine a second portion of piezo audio devices positioned on a second side of the dividing line. As described herein, the second portion of the piezo audio devices can be physically located on the second side of the dividing line in a particular orientation of the display 344.

In some examples, the memory resource 304 can include instructions 340 that are executable by the processing resource 302 to assign a first piezo audio device of the first portion of piezo audio devices to a first channel and a second piezo audio device of the first portion of piezo audio devices to a second channel. In some examples, the dividing line can be utilized to generate portions of the display 344 to assign a particular quantity of channel assignments. In this example, a first channel assignment can be assigned to the first portion of piezo audio devices and a second channel assignment can be assigned to the second portion of piezo audio devices. However, additional dividing lines and/or portions of the display 344 can be generated to assign additional channel assignments to the additional portions.

In some examples, the dividing line of the display 344 can be utilized to generate separate viewing areas for multiple users. For example, the first side of the dividing line can be utilized to display a first user interface for a first user and the second side of the dividing line can be utilized to display a second user interface for a second user. In some examples, additional dividing lines can be utilized to generate additional viewing areas for additional users. In some examples, each viewing area can include a plurality of channel assignments. For example, the first side of the dividing line can include a first channel assignment and a second channel assignment. In this example, the second side of the dividing line can include a first channel assignment and a second channel assignment.

In a specific example, the first side of the dividing line can be coupled to a first sound system that includes a right channel assignment and a left channel assignment. In this example, the second side of the dividing line can be coupled to a second sound system that includes a right channel assignment and a left channel assignment. In this example, the first sound system can be different than the second sound system. That is, the first sound system can be utilized to generate sound corresponding to images displayed on the first side of the dividing line. In addition, the second sound system can be utilized to generate sound corresponding to images displayed on the second side of the dividing line. Thus, the first piezo audio device and the second piezo audio device can be utilized to generate sounds that correspond to images or instructions related to the first side of the dividing line.

In some examples, the memory resource 304 can include instructions 342 that are executable by the processing resource 302 to assign a third piezo audio device of the second portion of piezo audio devices to the first channel and a fourth piezo audio device of the second portion of piezo audio devices to the second channel. As described herein, the second side of the dividing line can include a physical location of the second portion of piezo audio devices. In some examples, the second side of the dividing line can be utilized independently of the first side of the dividing line. Thus, the sound generated by the second portion of piezo audio devices can be utilized to generate sound that corresponds to the second side of the dividing line and not related to the first side of the dividing line.

In some examples, the second side of the dividing line can include a plurality of channel assignments that are independent of the channel assignments of the first side of the dividing line. For example, the second side of the dividing line can include a right channel assignment and a left channel assignment that are both positioned on the second side of the dividing line to provide stereo sound to the second side of the dividing line. In a similar way, the first side of the dividing line can include a plurality of channel assignments that are independent of the channel assignments of the first side. For example, the first side of the dividing line can include a right channel assignment and a left channel assignment that are both positioned on the first side of the dividing line to provide stereo sound to the first side of the dividing line.

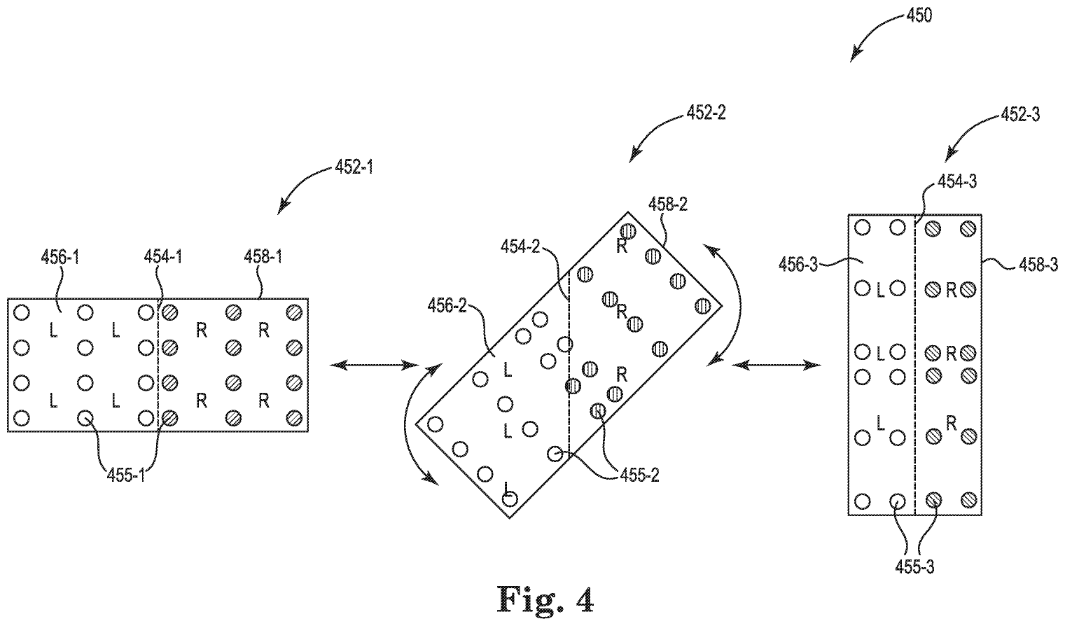

FIG. 4 illustrates an example of a system 450 for stereophonic balance of displays consistent with the disclosure. In some examples, the system 450 can illustrate a plurality of display orientations 452-1, 452-2, 452-3. For example, display orientation 452-1 can be a landscape orientation for a display, display orientation 452-2 can be an intermediate orientation between a landscape orientation and a portrait orientation, and display orientation 452-3 can be a portrait orientation. As used herein, a landscape orientation can be an orientation of the display when the top and bottom sides are relatively longer than the right and left sides. As used herein, a portrait orientation can be an orientation of the display when the top band bottom side are relatively shorter than the right and left sides.

As described herein, the displays can include audio devices 455-1, 455-2, 455-3 represented by circles. In some examples, the audio devices 455-1, 455-2, 455-3 can be positioned within an enclosure of a corresponding display represented by the display orientations 452-1, 452-2, 452-3. For example, the audio devices 455-1, 455-2, 455-3 can be piezo audio devices positioned within an enclosure of a display. In some examples, the audio devices 455-1, 455-2, 455-3 can be positioned between the screen or glass of the display and a protective portion (e.g., bucket of the display, etc.) of the enclosure. For example, an array of piezo audio devices 455-1, 455-2, 455-3 can be positioned between a screen positioned at a first side of the enclosure and a second side of the enclosure that includes a protective surface. As used herein, the screen of the display can be a device for projecting the images. In some examples, the second side of the enclosure can be the rear of the enclosure that is opposite of the screen. In this way, the piezo audio devices 455-1, 455-2, 455-3 can be positioned behind a screen of the system 450 such that the piezo audio devices 455-1, 455-2, 455-3 are not visible when looking at the screen on the first side or the enclosure on the second side.

In some examples, the audio devices 455-1, 455-2, 455-3 can be positioned between a first side of the enclosure and a second side of the enclosure. In some examples, the first side of the enclosure can include a first screen or glass to display images and the second side of the enclosure can include a second screen or glass to display images. In these examples, the audio devices 455-1, 455-2, 455-3 can be positioned between first screen or glass and the second screen or glass.

In some examples, the screen or glass can be utilized to display images by a computing device or media source (e.g., cable service, satellite dish service, etc.) in a first mode and display images that correspond to a physical location of the audio devices 455-1, 455-2, 455-3 in a second mode. In some examples, the screen or glass in the second mode can be utilized to display a relative position of the audio devices 455-1, 455-2, 455-3 within the enclosure. For example, the audio devices 455-1, 455-2, 455-3 can be positioned within the display such that a screen or protective surface of the enclosure blocks the audio devices 455-1, 455-2, 455-3 from the view of a user. In addition, the enclosure can prevent physical access to the audio devices 455-1, 455-2, 455-3 when the audio devices 455-1, 455-2, 455-3 are positioned within the enclosure. In this example, the display can project an image at each location of the audio devices 455-1, 455-2, 455-3 relative to the screen or glass of the display in the second mode. In this way, an image can be displayed to illustrate a physical location of the audio devices 455-1, 455-2, 455-3 positioned within the enclosure in the second mode and images generated by a computing device or media source can be viewed in the first mode without illustrating the location of the audio devices 455-1, 455-2, 455-3, which could distract a user viewing the images generated by the computing device or media source.

As described herein, an image can be displayed on the screen or glass in a particular mode (e.g., second mode as described herein, etc.) to illustrate the physical location of the audio devices 455-1, 455-2, 455-3. In some examples, image can include particular properties to identify a channel assignment or particular settings for each of the audio devices 455-1, 455-2, 455-3. For example, a first audio device from the audio devices 455-1, 455-2, 455-3 can be displayed in a first color, pattern, and/or shape when the first audio device has a first channel assignment. In this example, a second audio device from the audio devices 455-1, 455-2, 455-3 can be displayed in a second color, pattern, and/or shape when the second audio device has a second channel assignment. In this example, the first audio device can be positioned on first side of a dividing line (e.g., dividing line 454-1, 454-2, 454-3, etc.) and the second audio device can be positioned on a second side of the dividing line. In this way, each of the audio devices 455-1, 455-2, 455-3 can be identified to have a corresponding channel assignment or particular setting.

In some examples, the image displayed on the screen or glass in a particular mode (e.g., second mode as described herein, etc.) to illustrate the physical location of the audio devices 455-1, 455-2, 455-3 can be updated in real time as the display rotates from a first position to a second position. As described further herein, the display can be rotated from a first position to a second position and a channel assignment can be altered based on a physical location of the audio devices 455-1, 455-2, 455-3 with respect to a dividing line (e.g., dividing line 454-1, 454-2, 454-3, etc.). For example, when an audio device from the (e.g., dividing line 454-1, 454-2, 454-3, etc.) is on a first side of the dividing line at a first position a first image that corresponds to a first channel assignment can be displayed at a relative location on the screen or glass. In this example, the display can be rotated such that the audio device is moved from the first side of the dividing line to a second side of the dividing line. In this example, the first image can be altered to a second image that corresponds to a second channel assignment to illustrate that the audio device has changed from the first channel assignment to the second channel assignment.

In some examples, the image corresponding to the channel assignment or setting can be altered as the display orientation is altered from a first position to a second position. In this way, the display can be rotated such that a first quantity of audio devices 455-1, 455-2, 455-3 are assigned to a first channel assignment or first setting and a second quantity of audio devices 455-1, 455-2, 455-3 are assigned to a second channel assignment or second setting. As illustrated in FIG. 4, audio devices 455-1, 455-2, 455-3 positioned on a first side 456-1, 456-2, 456-3 of a dividing line 454-1, 454-2, 454-3 can be a first color (e.g., solid color, etc.) and audio devices 455-1, 455-2, 455-3 positioned on a second side 458-1, 458-2, 458-3 of the dividing line 454-1, 454-2, 454-3 can be a second color (e.g., striped color, etc.). Even though a solid color and a striped color are illustrated in FIG. 4, examples are not so limited.

In some examples, the system 450 can include a dividing line 454-1, 454-2, 454-3. As described herein, the dividing line 454-1, 454-2, 454-3 can be utilized to generate a first side 456-1, 456-2, 456-3 and a second side 458-1, 458-2, 458-3 of the display for each orientation 452-1, 452-2, 452-3. In some examples, the dividing line 454-1, 454-2, 454-3 can be utilized to generate a quantity of portions for altering channel assignments for the audio devices 455-1, 455-2, 455-3. For example, the dividing line 454-1, 454-2, 454-3 can generate the first side 456-1, 456-2, 456-3 for a first channel assignment (e.g., left channel assignment, etc.) and generate the second side 458-1, 458-2, 458-3 for a second channel assignment (e.g., right channel assignment, etc.).

In some examples, the dividing line 454-1, 454-2, 454-3 can remain in the same or similar position as the orientation of the display alters from the first orientation 452-1, to the second orientation 452-2, and/or to the third orientation 452-3. In some examples, a physical location with respect to the dividing line 454-1, 454-2, 454-3 can change for the audio devices 455-1, 455-2, 455-3 when the display is altered between the display orientations 452-1, 452-2, 452-3. For example, a particular audio device of the audio devices 455-1, 455-2, 455-3 can be located on a first side 456-1 (e.g., left side) of the dividing line 454-1 in the first orientation 452-1 and be located on a second side 458-3 (e.g., right side) of the dividing line 454-3 in the third orientation 452-3. In some examples, the particular audio device can be dynamically altered to a particular channel assignment based on a location with respect to the dividing line 454-1, 454-2, 454-3 or orientation 452-1, 452-2, 452-3.

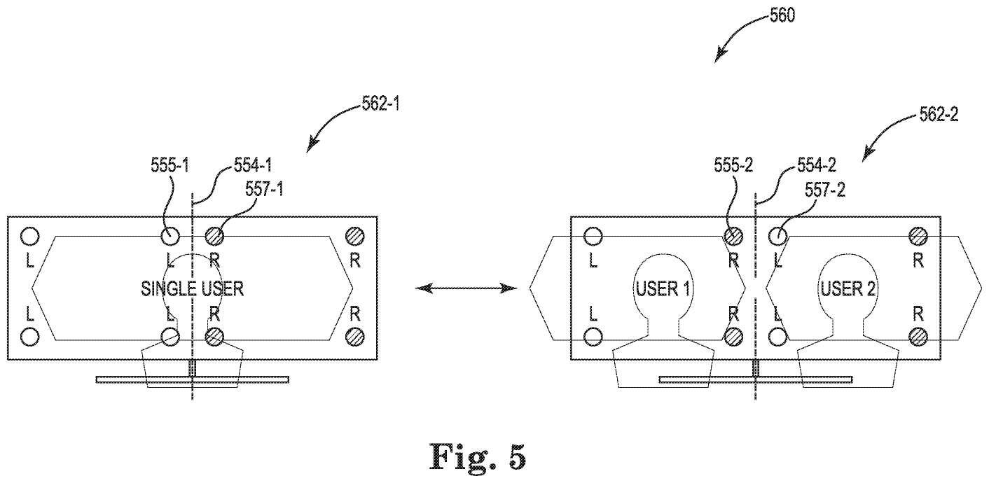

FIG. 5 illustrates an example of a system 560 for stereophonic balance of displays consistent with the disclosure. In some examples, the system 560 can include a first display mode 562-1 and a second display mode 562-2. In some examples, the first display mode 562-1 can correspond to a first sound mode and the second display mode 562-2 can correspond to a second sound mode. In some examples, the system 560 can include a plurality of audio devices 555-1, 557-1, 555-2, 557-2. As described herein, the audio devices 555-1, 557-1, 555-2, 557-2 can be piezo audio devices positioned within an enclosure of a display.

In some examples, the first display mode 562-1 can be a stereo sound mode to generate stereo sound across the display. For example, the first display mode 562-1 can have a corresponding sound mode that can include two channel assignments (e.g., left channel assignment, right channel assignment, etc.). In this example, the display mode 562-1 can utilize a dividing line 554-1 to generate a left side and a right side of the dividing line 554-1. In some examples, a first audio device 555-1 can be located on a first side of the dividing line 554-1 and a second audio device 557-1 can be located on a second side of the dividing line 554-1. In some examples, the first audio device 555-1 can be assigned a first channel assignment (e.g., left channel assignment) and the second audio device 557-1 can be assigned a second channel assignment (e.g., right channel assignment). In this way, a first channel assignment can be utilized for audio devices on a first side of the dividing line 554-1 and a second channel assignment can be utilized for audio devices on a second side of the dividing line 554-1.

In some examples, the second display mode 562-2 can be a multi-user sound mode. As described herein, a display can utilize a dividing line 554-2 to utilize a first user interface on the first side of the dividing line 554-2 and utilize a second user interface on the second side of the dividing line 554-2. In some examples, the first side of the dividing line 554-2 can provide stereo sound for the first user interface and the second side of the dividing line 554-2 can provide stereo sound for the second user interface. In some examples, a first audio device 555-2 can be positioned on a left side of the dividing line 554-2. In these examples, the first audio device 555-2 can be positioned on a right side of the user interface positioned on the left side of the dividing line 554-2. In these examples, the audio device 555-2 can be assigned to a right channel to provide stereo sound for the left side of the dividing line 554-2.

In a similar example, the audio device 557-2 can be positioned on a right side of the dividing line 554-2 and can correspond to a user interface positioned or projected on the right side of the dividing line 554-2. In some examples, the audio device can be positioned on a right side of the dividing line, but on a left side of the user interface positioned on the right side of the dividing line 554-2. In this way, the audio device 557-2 can be assigned to a left channel assignment to provide stereo sound on the right side of the dividing line 554-2.

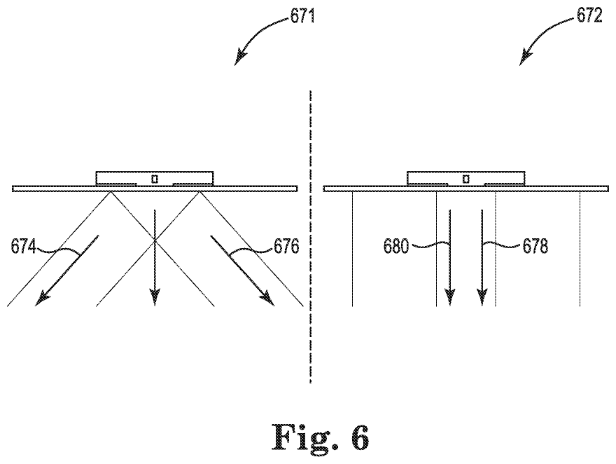

FIG. 6 illustrates an example of a system 670 for stereophonic balance of displays consistent with the disclosure. In some examples, the system 670 can illustrate a display with audio devices that ae embedded within an enclosure of the display. For example, the displays illustrated in FIG. 6 can include piezo audio devices that are positioned within the enclosure of the displays. In some examples, the system 670 can illustrate a first display in a diffused mode 671 and a second display in a directional mode 672. In some examples, the system 670 can be switched from the diffused mode 671 to the directional mode 672 in response to an input (e.g., selection of a button, selection utilizing the display, etc.).

As used herein, a diffused mode 671 can include a mode where the audio devices within the enclosure of the display are generating sound in a first direction 674 and a second direction 676 that is different than the first direction 674. In some examples, the diffused mode 671 can be a mode to generate a sound that can be heard by users in a surrounding area of the display since the audio devices are generating sound in the first direction 674 and the second direction 676.

In some examples, the display can include a dividing line that can generate a first portion and a second portion. In these examples, the audio devices positioned in the first portion can generate sound in the first direction 674 and devices positioned in the second portion can generate a sound in the second direction 676.

In some examples, the directional mode 672 can be utilized to prevent users surrounding the display from hearing the sound generated by the audio devices. For example, the sound generated by the audio devices can be directed in a single direction (e.g., direction 680, direction 678, etc.). As described herein, a display can utilize a dividing line to generate a first portion and a second portion of the display. For example, the dividing line can generate a right portion of the display and a left portion of the display. In this example, a first portion of the audio devices can be positioned on the right portion of the display and a second portion of the audio devices can be positioned on the left portion of the display. In some examples, a first portion of the audio devices can be utilized to generate sound in the direction 680 and a second portion of the audio devices can be utilized to generate sound in the direction 678.

In some examples, the diffused mode 671 or the directional mode 672 can be applied to a portion of the display as described herein. For example, the display can include a dividing line as described herein. In this example, the dividing line can generate a first portion and a second portion. In this example, the first portion can have a mode independently applied and the second portion can have a mode independently applied. For example, the directional mode 672 can be applied to a first portion or first side of the dividing line and the diffused mode 671 can be applied to a second portion or second side of the dividing line.

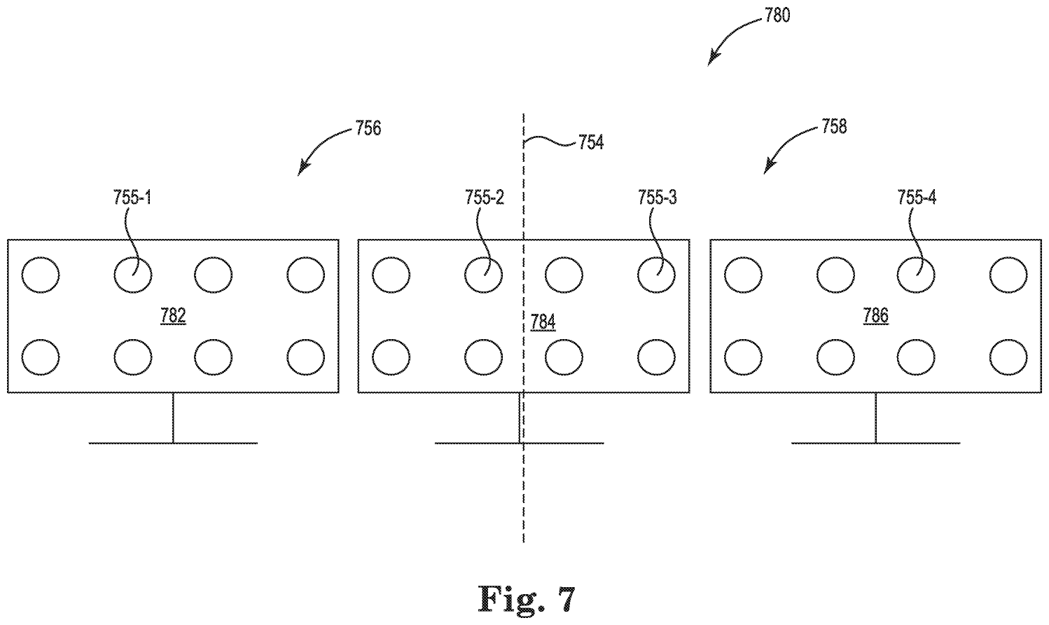

FIG. 7 illustrates an example of a system 780 for stereophonic balance of displays consistent with the disclosure. System 780 can include a plurality of displays 782, 784, 786. In some examples, the plurality of displays 782, 784, 786 can each include a corresponding array of audio devices positioned within the corresponding plurality of displays 782, 784, 786. For example, the display 782 can include a first array of audio devices including audio device 755-1, the display 784 can include a second array of audio devices including audio devices 755-2, 755-3, and the display 786 can include a third array of audio devices including audio device 755-4.

In some examples, the plurality of displays 782, 784, 786 can be coupled to a computing device and utilize a particular user interface. For example, the plurality of displays 782, 784, 786 can be coupled to a computing device or sound system to generate a particular sound mode across the plurality of displays 782, 784, 786. In some examples, a dividing line 754 can be utilized to generate a first side 756 (e.g., left side) and a second side 758 (e.g., right side) of the plurality of displays 782, 784, 786. In some examples, the plurality of displays 782, 784, 786 can be utilized to generate a stereo sound by assigning a plurality of channel assignments to the plurality of audio devices 755-1, 755-2, 755-3, 755-4.

In some examples, a dividing line 754 can be utilized to split display 784 and generate a first side 756 and a second 758 across the plurality of displays 782, 784, 786. In some examples, audio devices 755-1, 755-2 can be assigned a first channel assignment when the audio devices 755-1, 755-2 are positioned on the first side 756 of the dividing line 754. In some examples, the audio devices 755-3, 755-4 can be assigned a second channel assignment when the audio devices 755-3, 755-4 are positioned on the second side 758 of the dividing line 754. In this way, stereo sound or multi-channel sound can be generated utilizing a plurality of displays 782, 784, 786.

The figures herein follow a numbering convention in which the first digit corresponds to the drawing figure number and the remaining digits identify an element or component in the drawing. Similar elements or components between different figures can be identified by the use of similar digits. For example, 102 can reference element “02” in FIG. 1, and a similar element can be referenced as 202 in FIG. 2. Elements shown in the various figures herein can be added, exchanged, and/or eliminated so as to provide a plurality of additional examples of the disclosure.

In addition, the proportion and the relative scale of the elements provided in the figures are intended to illustrate the examples of the disclosure, and should not be taken in a limiting sense. As used herein, the designator “N”, particularly with respect to reference numerals in the drawings, indicates that a plurality of the particular feature so designated can be included with examples of the disclosure. The designators can represent the same or different numbers of the particular features. Further, as used herein, “a plurality of” an element and/or feature can refer to more than one of such elements and/or features.

What is claimed:

1. A system, comprising:
a display comprising an enclosure with audio devices positioned within the enclosure; and
a computing device comprising instructions executable by a processing resource to:
determine an orientation of the display; and
alter a stereophonic balance of the audio devices based on the determined orientation of the display.

2. The system of claim 1, wherein the stereophonic balance includes right channel and left channel assignments for the audio devices.

3. The system of claim 1, wherein the stereophonic balance includes a directionality of a sound generated by the audio devices.

4. The system of claim 1, wherein the instructions to alter the stereophonic balance includes instructions to individually alter the stereophonic balance of each of the audio devices.

5. The system of claim 1, wherein the computing device comprises instructions executable by the processing resource to alter the stereophonic balance of the audio device between a directional mode to a diffused mode based on an input.

6. The system of claim 5, wherein the directional mode allows the audio devices to generate sound in a single direction and the diffused mode allows the audio devices to generate sounds in a plurality of directions.

7. The system of claim 1, wherein the computing device comprises instructions executable by the processing resource to alter the stereophonic balance of a first portion of the audio devices in a first direction and alter the stereophonic balance of a second portion of the audio devices in a second direction.

8. A non-transitory machine-readable medium including instructions executable by a processing resource to:
determine a location of a plurality of piezo audio devices within an enclosure of a display;
determine an orientation of the display;
determine a dividing line of the display at the orientation;
alter a first portion of the plurality of piezo audio devices positioned on a first side of the dividing line to a first channel assignment; and
alter a second portion of the plurality of piezo audio devices positioned on a second side of the dividing line to a second channel assignment.

9. The medium of claim 8, comprising instructions executable by the processing resource to:
determine the orientation of the display is altered to a different orientation; and
alter the first portion of the plurality of piezo devices and the second portion of the plurality of piezo audio devices based on the different orientation.

10. The medium of claim 9, wherein the different orientation is a rotated orientation of the display,

11. The medium of claim 9, wherein one of the first portion of the plurality of piezo devices is altered to the second channel assignment and one of the second portion of the plurality of piezo devices is altered to the first channel assignment in response to the different orientation.

12. A display comprising:
an array of piezo audio devices positioned within an enclosure of the display, wherein the array of piezo audio devices includes a plurality of piezo audio devices positioned within the enclosure; and
a computing device comprising instructions executable by a processing resource to:
determine a dividing line of the display;
determine a first portion of piezo audio devices positioned on a first side of the dividing line;
determine a second portion of piezo audio devices positioned on a second side of the dividing line;
assign a first piezo audio device of the first portion of piezo audio devices to a first channel and a second piezo audio device of the first portion of piezo audio devices to a second channel; and
assign a third piezo audio device of the second portion of piezo audio devices to the first channel and a fourth piezo audio device of the second portion of piezo audio devices to the second channel.

13. The display of claim 12, wherein an image of the array of piezo audio devices is displayed at a location relative to a screen of the display.

14. The display of claim 13, wherein a color of the image corresponds to a channel assignment of a corresponding piezo audio device of the array of piezo audio devices.

15. The display of claim 12, wherein the computing device comprises instructions executable by the processing resource to alter the first portion of the piezo audio devices to a first directional mode and alter the second portion of the piezo audio devices to a second directional mode.
